(19) United States
(12) Patent Application Publication
(10) Pub. No.: US 2017/0328542 A1
(43) Pub. Date: Nov. 16, 2017

(54) LENS AND ILLUMINATING DEVICE INCLUDING THE LENS

(71) Applicant: Nextorch Industries Co., Ltd., Guangdong (CN)

(72) Inventors: Gaofang HE, Guangdong (CN); Bing LIANG, Guangdong (CN)

(21) Appl. No.: 15/151,063

(22) Filed: May 10, 2016

(51) Int. Cl. F21V 14/02; F21V 5/04; F21V 7/00; F21V 13/04

(52) U.S. Cl. CPC F21V 14/02; F21V 13/04; F21V 5/045; F21V 7/0066

(57) ABSTRACT

The present invention provides a lens and an illuminating device including the lens, wherein the lens includes a first lens part and a second lens part, the second lens part is provided around the first lens part, the first lens part and the second lens part are provided in an enclosed manner to form a light emitting part and an accommodating part for accommodating a light source, the light emitting part and the accommodating part locate on two opposite sides of the first lens part, and a surface of the first lens part facing the light emitting part is provided with a plurality of concentrically-arranged annular bulges so as to change the angles of lights according to a location of the light source in the accommodating part. The technical solution of the present invention can change a light emitting angle so as to adapt to use requirements of different near and far occasions.

### FIELD OF THE INVENTION

The present invention relates to a technical field of illuminating products, particularly to a lens and an illuminating device including the lens.

### BACKGROUND OF THE INVENTION

A concave reflecting mirror, which is applied as an optical system of most portable illuminating products currently used on the market, is called a parabolic reflector in the industry. Such a concave reflecting mirror is formed by symmetrically revolving one parabola along a circumference. Generally, the concave reflecting mirror only has a fixed focusing effect, which means that the concave reflecting mirror enables divergent lights emitted by a light source placed on a focus of the parabola to converge along a direction in which the concave reflecting mirror opens to become a light beam having a fixed light emitting angle.

Limited by inherent properties of the concave reflecting mirror, an illuminating product using such a concave reflecting mirror as an optical system can hardly change a light emitting angle during application, thus failing to adapt to use requirements of different near and far occasions, and such use limitation is more apparent especially in the field of portable illumination.

### SUMMARY OF THE INVENTION

The present invention aims to provide a lens and an illuminating device including the lens, so that a light emitting angle can be changed to adapt to use requirements of different near and far occasions.

A lens is provided according to an aspect of the present invention so as to achieve the purpose above, comprising a first lens part and a second lens part. The second lens part is provided around the first lens part, the first lens part and the second lens part are provided in an enclosed manner to form a light emitting part and an accommodating part for accommodating a light source, the light emitting part and the accommodating part locate on two opposite sides of the first lens part, a surface of the first lens part facing the light emitting part is provided with a plurality of concentrically-arranged annular bulges so as to change the angles of lights according to a location of the light source in the accommodating part.

Further, among the plurality of annular bulges, one side of at least one annular bulge facing the central axis of the lens is provided with a conical surface and the conical surface is gradually away from the central axis of the lens in a direction away from the accommodating part.

Further, an inclination direction of the conical surface is adapted to a transmission direction of the lights in the first lens part, and included angles between the conical surfaces of the plurality of annular bulges and the central axis increase gradually along a direction away from the central axis.

Further, the first lens part comprises: a first incident plane, wherein the first incident plane is a plane vertical to the central axis of the lens; and a first exit plane, wherein the first exit plane serves as a surface facing the light emitting part and is provided with the plurality of annular bulges.

Further, the first lens part comprises: a first incident plane, wherein the first incident plane is a cambered surface and a recess part of the cambered surface faces the light emitting part; and a first exit plane, wherein the first exit plane serves as a surface facing the light emitting part and is provided with the plurality of annular bulges.

Further, the first lens part comprises: a first incident plane, wherein the first incident plane is a cambered surface and a recess part of the cambered surface faces the accommodating part; and a first exit plane, wherein the first exit plane serves as a surface facing the light emitting part and is provided with the plurality of annular bulges.

Further, the second lens part comprises: a second incident plane, wherein the second incident plane and the first incident plane are provided in an enclosed manner to form the accommodating part; a second exit plane, wherein the second exit plane and the first exit plane are provided in an enclosed manner to form the light emitting part; and a fully reflecting surface, wherein the fully reflecting surface is connected between the second incident plane and the second exit plane.

Further, the lights emitted by the light source arrive at the fully reflecting surface after being refracted on the second incident plane, an angle of incidence of the lights on the fully reflecting surface is larger than or equal to a critical angle of total reflection, and the lights arrive at the second exit plane after being reflected by the fully reflecting surface, wherein an angle of incidence of the lights on the second exit plane is smaller than the critical angle of total reflection.

Further, a cross section of the accommodating part increases gradually along a direction away from the first lens part, and a cross section of the light emitting part increases gradually along the direction away from the first lens part.

An illuminating device is provided according to another aspect of the present invention, comprising a lens and a light source, wherein the lens is the aforementioned lens and the light source is moveably provided in the accommodating part of the lens along an axial direction of the lens.

Further, among the plurality of annular bulges, the focus of each annular bulge locates on the central axis of the lens and the focuses of the plurality of annular bulges all locate in a moving range of the light source.

By applying the technical solution of the present invention, a lens comprises a first lens part and a second lens part, wherein the second lens part is provided around the first lens part, and the first lens part and the second lens part are provided in an enclosed manner to form a light emitting part and an accommodating part. A light source is placed in the accommodating part. After passing through the first lens part and the second lens part, lights emitted by the light source form a light beam which is emitted from the light emitting part, a surface of the first lens part facing the light emitting part is provided with a plurality of concentrically-arranged annular bulges, and the light source moves along an axial direction of the lens in the accommodating part so that these annular bulges can adjust the angles of the lights according to a location of the light source so as to implement a zoom function. The first lens part and the second lens part may be matched with each other so that light beams of different angles can be formed when the lens is used, thereby adapting to use requirements of different near and far occasions.

### BRIEF DESCRIPTION OF THE DRAWINGS

The accompanying drawings of the specification, which form a part of the present application, are used for providing further understanding of the present invention. The schematic embodiments of the present invention and description thereof are used for explaining the present invention, instead of forming improper limitation to the present invention. In the accompanying drawings:

FIG. 1 shows a schematic diagram of a lens according to a first embodiment of the present invention;

FIG. 2 shows an enlarged view of part A according to FIG. 1;

FIG. 3 shows a schematic diagram of focusing performed by the lens matched with the light source according to the first embodiment of the present invention; and

FIG. 4 shows a schematic diagram of pan-focusing performed by the lens matched with the light source according to the first embodiment of the present invention;

FIG. 5 shows a schematic diagram of a lens according to a second embodiment of the present invention; and

FIG. 6 shows a schematic diagram of a lens according to a third embodiment of the present invention.

### DETAILED DESCRIPTION OF THE INVENTION

The present invention will be expounded hereinafter with reference to the accompanying drawings and in combination with the embodiments. It needs to be noted that the embodiments in the present application and the characteristics in the embodiments may be combined with each other if there is no conflict.

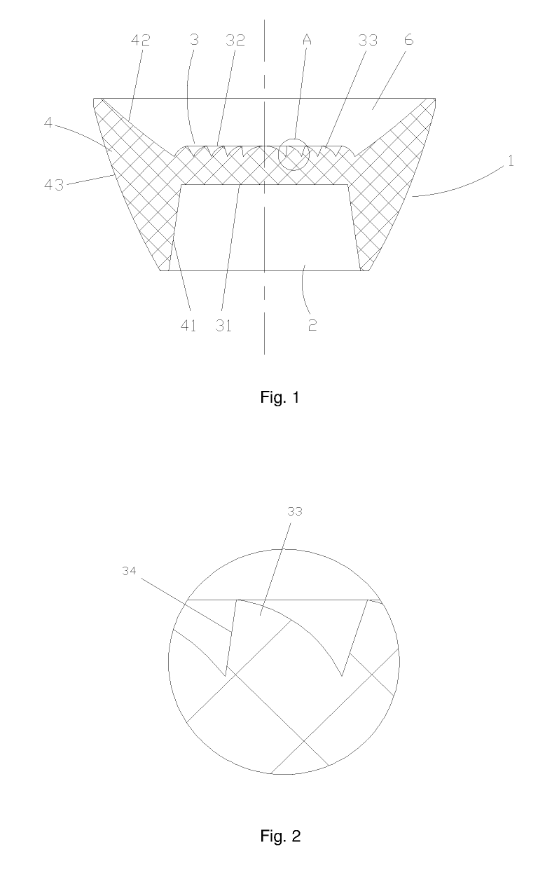

As shown in FIG. 1 to FIG. 4, a lens 1 is provided according to a first embodiment of the present invention. Referring to FIG. 1, the lens 1 comprises a first lens part 3 and a second lens part 4, wherein the second lens part 4 is provided around the first lens part 3 and is fixedly connected to the periphery of the first lens part 3. The first lens part 3 and the second lens part 4 are provided in an enclosed manner to form an accommodating part 2 and a light emitting part 6, and the accommodating part 2 and the light emitting part 6 locate on two opposite sides of the first lens part 3, wherein the accommodating part 2 is used for arranging a light source 5. Lights emitted by the light source 5 are adjusted by the first lens part 3 and the second lens part 4, and then emitted from the light emitting part 6 to implement a required focusing or pan-focusing effect. A surface of the first lens part 3 facing the light emitting part 6 is provided with a plurality of annular bulges 33. These annular bulges 33 are arranged concentrically, which can change the angles of the lights passing through the surface, while a location of the light source 5 in the accommodating part 2 may be adjusted, so as to implement a zoom effect.

Here, the first lens part 3 and the second lens part 4 may be shaped integrally. In other words, they are machined and shaped directly on a blank material. They may be also separate structures. In other words, the first lens part 3 and the second lens part 4 are machined separately, and the first lens part 3 and the second lens part 4 are assembled subsequently. They may be assembled by being fixedly adhered or the first lens part 3 and the second lens part 4 may be in interference fit.

The first lens part 3 and the second lens part 4 are formed by transparent plastic or optical glass, preferably an optical grade (PolyMethyl Methacrylate) (PMMA) material. These materials belong to the traditional art, and improvement of the materials is not involved in the present invention.

Referring to FIG. 1 and FIG. 2, the first lens part 3 comprises a first incident plane 31 and a first exit plane 32, and the first incident plane 31 and the first exit plane 32 locate on two opposite sides of the first lens part 3. The first incident plane 31 is a smooth plane vertical to the central axis of the lens 1. The lights emitted by the light source 5 arrive at the first exit plane 32 after being refracted by the first incident plane 31 and are emitted by the first exit plane 32. The first exit plane 32 is the surface which faces the light emitting part 6 and is provided with the plurality of annular bulges 33.

According to different use occasions, the annular bulges 33 on the first exit plane 32 may be designed as a conventional Fresnel lens structure. In other words, the plurality of concentric annular bulges 33 are sorted by size in turn. Each annular bulge 33 is a zigzag-shaped structure on the section of the lens 1 along an axial direction thereof. An edge of each zigzag-shaped structure back to the direction of the central axis of the lens is an arc segment, while an edge facing the direction of the central axis of the lens is a linear segment, and the linear segment is parallel to the central axis of the lens 1. The lights will change their directions when passing the annular bulges 33, thereby changing a light emitting angle.

Of course, the annular bulges 33 on the first exit plane 32 may also apply other structures. Referring to FIG. 1 and FIG. 2, in another structure, the plurality of concentric annular bulges 33 are arranged by size on the first exit plane 32 in turn, each annular bulge 33 is a zigzag-shaped structure on the section of the lens 1 along the axial direction thereof. An edge of each zigzag-shaped structure back to the direction of the central axis of the lens is an arc segment, and an edge facing the direction of the central axis is a linear segment. Referring to FIG. 2, which is different from a conventional Fresnel lens is that a distance between the linear segment of the zigzag-shaped structure and the central axis of the lens 1 in the first lens part 3 having such a structure gradually increases along a direction away from the accommodating part 2. In other words, for a three-dimensional structure of the first lens part 3, a conical surface 34 is formed on one side of each annular bulge 33 facing the central axis, and the conical surface 34 is gradually away from the central axis of the lens 1 along the direction away from the accommodating part 2. The reason to design the annular bulges 33 on the first exit plane 32 as such a structure having a conical surface 34 is that, instead of being transmitted along a direction parallel with the central axis of the lens 1, most lights emitted by the light source 5 will change their directions to form an included angle with the central axis of the lens 1 after entering the first lens part 3 from the air. For this reason, such an annular bulge 33 provided with a conical surface 34 can reduce light loss more effectively, improve light emitting efficiency and has better illumination effect compared with an annular bulge 33 on the conventional Fresnel lens.

Preferably, an inclination direction of the conical surfaces 34 of the annular bulges 33 is adapted to a transmission direction of the lights in the first lens part 3, and the included angles between the conical surfaces 34 of the plurality of annular bulges 33 and the central axis increase gradually along a direction away from the central axis of the lens 1, thereby adapting to divergence angles of lights on different locations, further reducing the light loss and improving the light emitting efficiency. The transmission direction of the lights in the first lens part 3 should be calculated according to different applied materials, and a specific calculation method is general knowledge in the art and will not be described repeatedly here.

Besides, among the plurality of annular bulges 33 of the first lens part 3, some annular bulges 33 may be designed according to the conventional Fresnel lens structure, which means that an edge of a linear segment of a zigzag-shaped structure facing the central axis is parallel with the central axis, while the remaining annular bulges 33 are designed according to the structures as shown in FIG. 1 and FIG. 2, which means that a linear segment edge of a zigzag-shaped structure facing the central axis inclines relative to the central axis. A specific structure applied to the annular bulges 33 on the first exit plane 32 needs to be selected according to a practical requirement.

Preferably, among the plurality of annular bulges 33, the focus of each annular bulge 33 locates on the central axis of the lens, and the focuses of all annular bulges 33 locate in a moving range of the light source 5, thereby implementing a better focusing and pan-focusing effect.

Referring to FIG. 1 and FIG. 2, the second lens part 4 comprises a second incident plane 41, a second exit plane 42 and a fully reflecting surface 43, wherein the second incident plane 41 and the first incident plane 31 of the first lens part 3 are provided in an enclosed manner to form the accommodating part 2. The light source 5 can move in the accommodating part 2 along the axial direction of the lens 1. The second exit plane 42 and the first exit plane 32 of the first lens part 3 are provided in an enclosed manner to form the light emitting part 6. The fully reflecting surface 43 is connected between the second incident plane 41 and the second exit plane 42. After the angles are adjusted by the first lens part 3, some of the lights emitted by the light source 5 are emitted, and the remaining lights are emitted after the angles are adjusted by the second lens part 4, and the two parts of lights are finally converged on the light emitting part 6 to form a required light beam. Therefore, the second lens part 4 here is also complementary to the first lens part 3, besides changing the directions of the lights. In other words, when only some lights can be irradiated on the first lens part 3 while the remaining lights fail to penetrate through the first lens part 3, the remaining lights can change directions with the help of the second lens part 4, thereby reducing the light loss.

Preferably, the second incident plane 41, the second exit plane 42 and the fully reflecting surface 43 need to satisfy the following conditions so as to maximally reduce the light loss: the lights emitted by the light source 5 are refracted after arriving at the second incident plane 41 from the air, the refracted lights arrive at the fully reflecting surface 43, an angle of incidence on the fully reflecting surface 43 is larger than or equal to a critical angle of total reflection, thereby ensuring that all lights arrives at the second exit plane 42 after being reflected and no light is refracted from the fully reflecting surface 43, and an angle of incidence of the lights arriving at the second exit plane 42 should be smaller than the critical angle of total reflection, thereby ensuring that all lights are refracted from the second exit plane 42 and there is no reflection of some lights on the second exit plane 42. In this way, it can be substantially ensured that all lights passing through the second incident plane 41 are emitted from the second exit plane 42, thereby maximally reducing the light loss.

Preferably, the light emitting part 6 is a recess space, and the cross section of the light emitting part 6 gradually increases along a direction away from the first lens part 3. Such a structure can reduce technique difficulty, and is easy to machine. In the structure, the first incident plane 31 and the second incident plane 41, which form the accommodating part 2, may be planes, and may be also cambered surfaces, and specific shapes should be deigned according to a practical requirement.

Preferably, the light emitting part 6 is a recess space, and the cross section of the light emitting part 6 gradually increases along a direction away from the first lens part 3. Such a structure is easy to implement a required light beam effect and easy to machine while reducing technique difficulty. In the structure, the second exit plane 42, which forms the light emitting part 6, may be a plane, and may be also a cambered surface, and a specific shape should be deigned according to a practical requirement.

Besides, the fully reflecting surface 43 may be a plane and may be also a cambered surface, and a specific shape should be deigned according to a practical requirement.

Focusing or pan-focusing may be implemented when the light source 5 moves in the accommodating part 2 along the axial direction of the lens 1. Specifically, pan-focusing is implemented when the light source 5 moves close to the first incident plane 31. However, the light source 5 may emit heat or the material of the lens 1 may melt at high temperature, thus the light source 5 should not be too close to the first incident plane 31. The minimum distance between the light source 5 and the first incident plane 31 should be calculated according to the material and the shape of the lens and a required light beam effect. A specific calculating method belongs to the traditional art and will not be described repeatedly here. Focusing is implemented when the light source 5 moves away from the first incident plane 31. However, the light source 5 should not be too far from the first incident plane 31 in consideration of light loss, and preferably locates near a plane where the maximum diameter of the accommodating part 2 locates.

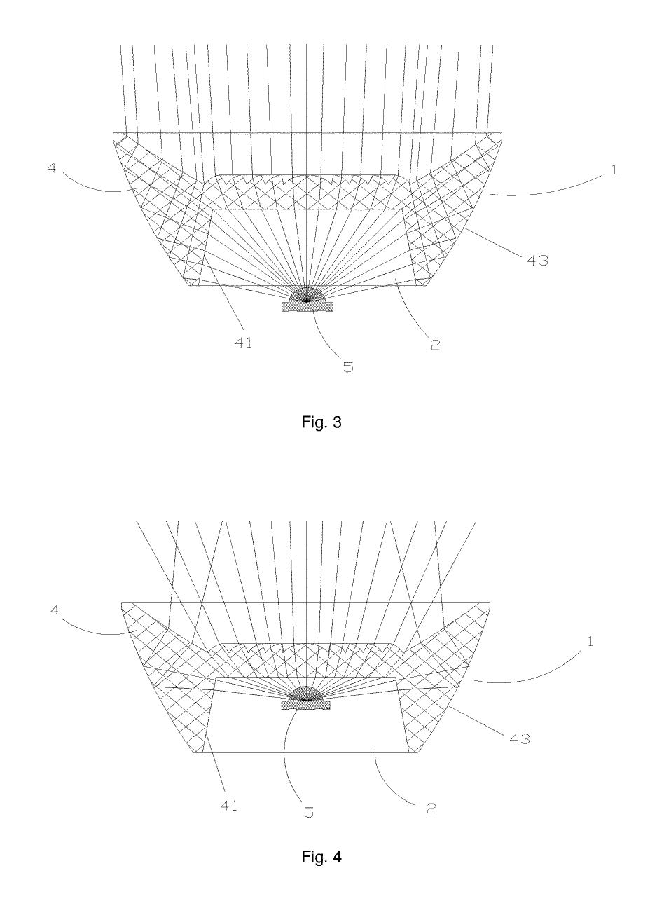

The functions of the first lens part 3 and the second lens part 4 during the focusing and the pan-focusing will be specifically described below with reference to FIG. 3 and FIG. 4.

FIG. 3 shows a focusing state. At the moment, the light source 5 preferably locates near the plane where the maximum diameter of the accommodating part 2 locates. The lights emitted by the light source 5 will be divided into two parts to pass through the lens 1. Some lights pass through the first incident plane 31 of the first lens part 3 and are refracted, and then arrive at the first exit plane 32, and enter the air from the light emitting part 6 after being refracted by the plurality of annular bulges 33 of the first exit plane 32. At the moment, the angles of this part of lights have been changed. An axially symmetrical light beam is emitted from the light emitting part 6, and the light beam is provided with a certain conical angle.

The other part of lights passes through the second incident plane 41 of the second lens part 4, is refracted for the first time, and then enters the second lens part 4. This part of lights is fully reflected after arriving at the fully reflecting surface 43. All of them are cast on the second exit plane 42, refracted on the second exit plane 42 for the second time, then leave the second lens part 4, and enter the air from the light emitting part 6. At the moment, the angles of this part of lights have been changed. An axially symmetrical light beam is emitted from the light emitting part 6, and the light beam is provided with a certain conical angle.

The lights having their angles changed respectively by the first lens part 3 and the second lens part 4 are converged at the light emitting part 6 to form a required light beam, thereby implementing the focusing effect.

FIG. 4 shows a pan-focusing state. At the moment, the light source 5 is close to the first incident plane 31. The lights emitted by the light source 5 will be divided into two parts to pass through the lens 1. Some lights pass the first incident plane 31 of the first lens part 3 and are refracted, and then arrive at the first exit plane 32, and enter the air from the light emitting part 6 after being refracted by the plurality of annular bulges 33 of the first exit plane 32. At the moment, the angles of this part of lights have been changed. An axially symmetrical light beam is emitted from the light emitting part 6, and the light beam has a certain conical angle. Since a distance between the light source 5 and the first incident plane 31 is smaller than a distance between the light source 5 and the first incident plane 31 in the focusing state, the conical angle of the light beam emitted from the light emitting part 6 will be larger than that of the light beam in the focusing state.

The other part of lights passes the second incident plane 41 of the second lens part 4, is refracted for the first time, and then enters the second lens part 4. This part of lights is fully reflected after arriving at the fully reflecting surface 43. All of them are cast on the second exit plane 42, refracted on the second exit plane 42 for the second time, then leave the second lens part 4, and enter the air from the light emitting part 6. At the moment, the angles of this part of lights have been changed. An axially symmetrical light beam converging inwards along a direction away from the lens 1 is emitted from the light emitting part 6. The lights that form the light beam further diverge respectively after being converged at a location away from the lens 1, and form light beams diverging along the direction away from the lens 1.

The lights having their angles changed respectively by the first lens part 3 and the second lens part 4 are converged at the light emitting part 6 to form a required light beam, thereby implementing the pan-focusing effect.

It needs to be noted that, the lights involved in this part does not comprise all theoretical lights. Affected by some factors comprising a practical process and material and so on, there will be inevitably some stray lights that are theoretical design and fail to satisfy the requirements above. Therefore, the lights in this part refer to those lights that are within a designed allowable loss.

The first embodiment as shown by FIG. 1 to FIG. 4 only illustrates a structure of the lens 1 as an example, and the specific shapes of the first incident plane 31, the second incident plane 41, the second exit plane 42 and the fully reflecting surface 43 that are illustrated do not represent limitation to the present invention. In practical application, the first incident plane 31, the second incident plane 41, the second exit plane 42 and the fully reflecting surface 43 may be designed with corresponding shapes according to practical requirements.

These selections and changes in shapes are only described in the second embodiment and the third embodiment below as examples.

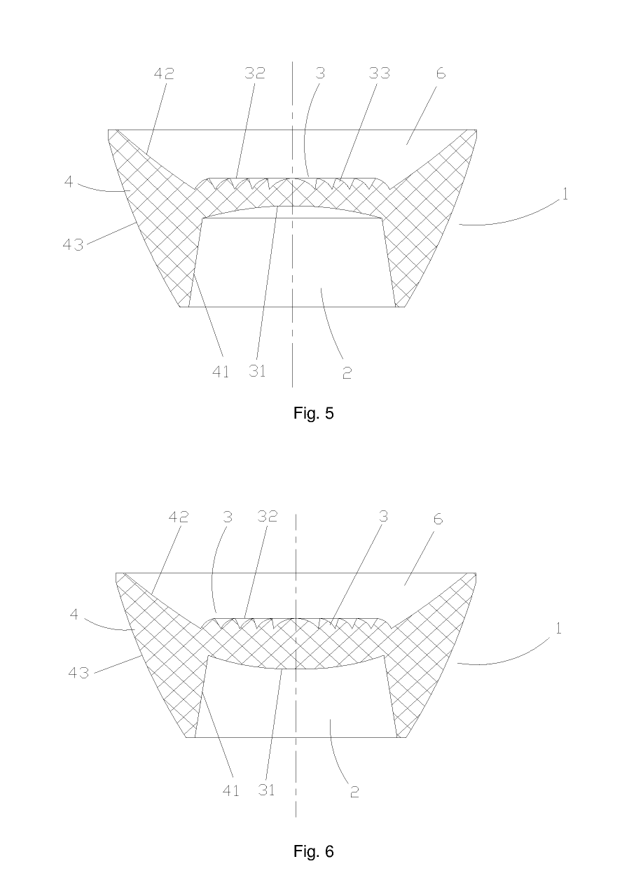

Referring to FIG. 5, a lens 1 is provided according to the second embodiment of the present invention. The structure of the lens 1 is substantially the same as that of the lens 1 in the first embodiment and what is different is that a first incident plane 31 of the lens 1 is a smooth cambered surface and a recess part of the cambered surface faces an accommodating part 2 in the present embodiment. The shape of the first incident plane 31 may be adjusted to form lights having different directions, thus better satisfying use requirements.

Referring to FIG. 6, a lens 1 is provided according to the third embodiment of the present invention. The structure of the lens 1 is substantially the same as that of the lens 1 in the first embodiment and what is different is that a first incident plane 31 of the lens 1 is a smooth cambered surface and a recess part of the cambered surface faces a light emitting part 6 in the present embodiment. The shape of the first incident plane 31 may be adjusted to form lights having different directions, thus better satisfying use requirements.

The present invention further provides an illuminating device, comprising a lens 1 and a light source 5, wherein the lens 1 is the aforementioned lens 1 and the light source 5 is provided in the accommodating part 2. The light source 5 may move along the axial direction of the lens 1 to implement a focusing effect and a pan-focusing effect, thus better satisfying an illuminating requirement.

Preferably, among the plurality of annular bulges 33, the focus of each annular bulge 33 locates on the central axis of the lens 1, and the focus of each annular bulges 33 locates in a moving range of the light source 5, thereby better forming symmetrical light beams, and satisfying a use requirement.

It may be seen from the description above that the embodiments of the present invention have implemented the following technical effect.

Firstly, the angles of lights may be changed as required, thus satisfying use requirements of different near and far occasions.

Secondly, the structure is simple and easy to machine.

What are described above are only preferred embodiments of the present invention, but are not used for limiting the present invention. The present invention may have various alternations and changes for those skilled in the art. Any modifications, equivalent replacements and improvements and the like made within the spirit and principles of the present invention should be included in the protection scope of the present invention.

1. A lens, wherein the lens comprises:
a first lens part (3) and a second lens part (4),
the second lens part (4) is provided around the first lens part (3),
the first lens part (3) and the second lens part (4) are provided in an enclosed manner to form a light emitting part (6) and an accommodating part (2) for accommodating a light source (5),
the light emitting part (6) and the accommodating part (2) being located on two opposite sides of the first lens part (3), and
a surface of the first lens part (3) facing the light emitting part (6) is provided with a plurality of concentrically-arranged annular bulges (33) so as to change the angles of lights according to a location of the light source (5) in the accommodating part (2),
among the plurality of annular bulges (33), one side of at least one annular bulge (33) facing the central axis of the lens is provided with a conical surface (34) and the conical surface (34) is gradually away from the central axis of the lens in a direction away from the accommodating part (2).

2. The lens according to claim 1, wherein an inclination direction of the conical surface (34) is adapted to a transmission direction of the lights in the first lens part (3), and included angles between the conical surfaces (34) of the plurality of annular bulges (33) and the central axis increase gradually along a direction away from the central axis.

3. The lens according to claim 1, wherein the first lens part (3) comprises:
a first incident plane (31), wherein the first incident plane (31) is a plane vertical to the central axis of the lens; and
a first exit plane (32), wherein the first exit plane (32) serves as a surface facing the light emitting part (6) and is provided with the plurality of annular bulges (33).

4. The lens according to claim 1, wherein the first lens part (3) comprises:
a first incident plane (31), wherein the first incident plane (31) is a cambered surface and a recess part of the cambered surface faces the light emitting part (6); and
a first exit plane (32), wherein the first exit plane (32) serves as a surface facing the light emitting part (6) and is provided with the plurality of annular bulges (33).

5. The lens according to claim 1, wherein the first lens part (3) comprises:
a first incident plane (31), wherein the first incident plane (31) is a cambered surface and a recess part of the cambered surface faces the accommodating part (2); and
a first exit plane (32), wherein the first exit plane (32) serves as a surface facing the light emitting part (6) and is provided with the plurality of annular bulges (33).

6. The lens according to claim 3, wherein the second lens part (4) comprises:
a second incident plane (41), wherein the second incident plane (41) and the first incident plane (31) are provided in an enclosed manner to form the accommodating part (2);
a second exit plane (42), wherein the second exit plane (42) and the first exit plane (32) are provided in an enclosed manner to form the light emitting part (6); and
a fully reflecting surface (43), wherein the fully reflecting surface (43) is connected between the second incident plane (41) and the second exit plane (42).

7. The lens according to claim 6, wherein:
the lights emitted by the light source (5) arrive at the fully reflecting surface (43) after being refracted on the second incident plane (41), an angle of incidence of the lights on the fully reflecting surface (43) is larger than or equal to a critical angle of total reflection, and
the lights arrive at the second exit plane (42) after being reflected by the fully reflecting surface (43), wherein an angle of incidence of the lights on the second exit plane (42) is smaller than the critical angle of total reflection.

8. The lens according to claim 1, wherein a cross section of the accommodating part (2) increases gradually along a direction away from the first lens part (3), and a cross section of the light emitting part (6) increases gradually along the direction away from the first lens part (3).

9. The lens according to claim 4, wherein the second lens part (4) comprises:
a second incident plane (41), wherein the second incident plane (41) and the first incident plane (31) are provided in an enclosed manner to form the accommodating part (2);
a second exit plane (42), wherein the second exit plane (42) and the first exit plane (32) are provided in an enclosed manner to form the light emitting part (6); and
a fully reflecting surface (43), wherein the fully reflecting surface (43) is connected between the second incident plane (41) and the second exit plane (42).

10. The lens according to claim 5, wherein the second lens part (4) comprises:
a second incident plane (41), wherein the second incident plane (41) and the first incident plane (31) are provided in an enclosed manner to form the accommodating part (2);
a second exit plane (42), wherein the second exit plane (42) and the first exit plane (32) are provided in an enclosed manner to form the light emitting part (6); and
a fully reflecting surface (43), wherein the fully reflecting surface (43) is connected between the second incident plane (41) and the second exit plane (42).

11. An illuminating device, comprising a lens (1) and a light source (5), wherein the lens (1) is the lens according to claim 1, and the light source (5) is moveably provided in the accommodating part (2) of the lens (1) along an axial direction of the lens (1).

12. The illuminating device according to claim 11, wherein among the plurality of annular bulges (33), a focus of each annular bulge (33) locates on the central axis of the lens (1) and the focuses of the plurality of annular bulges (33) all locate in a moving range of the light source (5).

13. An illuminating device, comprising a lens (1) and a light source (5), wherein the lens (1) is the lens according to claim 2, and the light source (5) is moveably provided in the accommodating part (2) of the lens (1) along an axial direction of the lens (1).

14. An illuminating device, comprising a lens (1) and a light source (5), wherein the lens (1) is the lens according to claim 3, and the light source (5) is moveably provided in the accommodating part (2) of the lens (1) along an axial direction of the lens (1).

15. An illuminating device, comprising a lens (1) and a light source (5), wherein the lens (1) is the lens according to claim 4, and the light source (5) is moveably provided in the accommodating part (2) of the lens (1) along an axial direction of the lens (1).

16. An illuminating device, comprising a lens (1) and a light source (5), wherein the lens (1) is the lens according to claim 5, and the light source (5) is moveably provided in the accommodating part (2) of the lens (1) along an axial direction of the lens (1).

17. An illuminating device, comprising a lens (1) and a light source (5), wherein the lens (1) is the lens according to claim 6, and the light source (5) is moveably provided in the accommodating part (2) of the lens (1) along an axial direction of the lens (1).

18. An illuminating device, comprising a lens (1) and a light source (5), wherein the lens (1) is the lens according to claim 7, and the light source (5) is moveably provided in the accommodating part (2) of the lens (1) along an axial direction of the lens (1).

19. An illuminating device, comprising a lens (1) and a light source (5), wherein the lens (1) is the lens according to claim 8, and the light source (5) is moveably provided in the accommodating part (2) of the lens (1) along an axial direction of the lens (1).
